(19) United States
(12) Patent Application Publication
(10) Pub. No.: US 2012/0027991 A1
(43) Pub. Date: Feb. 2, 2012

(54) Floor mat

(75) Inventor: Erik Anderson, Cleveland, TN (US)

(73) Assignee: REMINGTON INDUSTRIES, INC.

(21) Appl. No.: 12/804,852

(22) Filed: Jul. 30, 2010

(51) Int. Cl. B32B 3/10; B32B 3/30

(52) U.S. Cl. 428/131; 428/167

(57) ABSTRACT

An improved floor mat having a cellular topography. Individual cells define a containment portion to contain liquid and debris. Part of the wall of the containment portion serves as a common wall for adjacent containment portions. The common wall between adjacent containment cells defines one or more openings so that the adjacent cells are in fluid communication with each other to distribute liquid as evenly as possible on the floor mat surface. The openings preferably are troughs that include intermediate ribs. The bottom of the trough is located at a higher elevation than the bottom of the containment portion. This allows the containment portion to hold a certain amount of liquid before spilling into another containment portion. The ribs extend upward and serve as cleaners for soles of shoes, and also help keep clothing from contacted the liquid and debris.

### 1. FIELD

The field of the present invention relates generally to a comprehensive and new technology for floor coverings, such as area rugs or floor mats, or other items for containing dirt, water and spills, controlling the contaminants from spilling onto underlying flooring, and not only cleaning the soles of shoes, but also providing a floor mat that is easily cleaned—all to protect the underlying surface. The technology is currently noted as “C3” and also may be the subject of a trademark registration application. In its preferred application, the technology is applied to floor mats for automotive interior applications.

### 2. BACKGROUND

In floor covering applications, an important feature always is the protection of the underlying surface provided by the covering. For automotive floor mats, the carpeted flooring is constantly exposed to dirt, water and other contaminants in addition to every day wear and tear from shoes. Existing floor mats are designed with one or more of those considerations in mind. However, floor mats are continuously being improved with protection of the underlying flooring in mind. For example, U.S. Pat. No. 7,597,949 B2 issued to Wright, discloses a Surface Protection System Mat for use in protecting floor surfaces from accidental liquid spills. The mat includes a top layer comprising an array of hexagonal-shaped funnels that direct fluid from the top layer to a lower liquid absorbing layer. U.S. Pat. No. 7,211,314 B2, issued to Nevision also discloses a mat having drain holes. U.S. Pat. No. 6,921,502 B2 issued to Nord, et al. discloses a cushioned rubber floor mat with a raised edge or border and a textured surface.

Other existing designs also have attempted to provide protection of the underlying carpet. However, existing floor mats do not adequately control and contain the debris from the floor mat to protect the underlying surface. Many existing floor mats are a mat having a single raised border with a pattern between. See e.g., U.S. Pat. No. D586, 601, issued to Robbins, III, and U.S. Pat. No. 525,576, issued to Lu. In reality those mats have only a single containment area, or cell, that cell being defined by the border. Thus all the liquid runs to the lowest point in the cell and can spill over onto the underlying flooring. Some existing floor mats have multiple “cells” such as U.S. Pat. No. 6,605,333, issued to Ferreira, et al, in FIG. 3. However, there is no way to control the distribution of a liquid spill in such a mat.

### 3. SUMMARY

The present invention comprises an improved floor mat designed to improve on the existing limitations of floor mats. The present invention includes features that clean dirt from shoes, as well as contain and control water and debris from spilling onto the underlying flooring. The floor mat includes a substrate having a top portion and a bottom portion. The substrate can be made of any material that is suitable for use as a floor covering such as rubber, PVC, either alone or in combination with carpeting. Preferably, the floor mat of the present invention is made from rubber or other similar flexible, yet durable material that is easily cleaned and resists wear and tear. The top portion of the mat includes a cellular topography. There are at least two cells located on the top portion. However, substantially the entire surface of the mat may contain the cellular topography. Each cell has a containment portion which is essentially an open compartment to catch, control and contain debris and liquid. Each containment portion comprises a base and a wall extending upwardly from the base to create a reservoir to hold contaminants. Adjacent containment portions share a common portion of the wall that extends upwardly from the base.

Each common portion of the wall preferably defines an opening to allow fluid communication between the containment portions. For configurations where numerous containment portions are located on the top portion of the mat, there may be several containment portions adjacent to each other. Each containment portion may share its wall with several other adjacent containment portions. One or more of the common portions of the wall may have an opening to allow fluid communication.

In a preferred embodiment, the opening is a trough. The bottom of the trough is above the base. Because of this configuration, each containment portion can hold a certain amount of debris and liquid. However, if the volume of debris/liquid is too great, the liquid will spill over into the adjacent cells through the opening or trough. Once the liquid has been contained, it ceases to spill over into other containment cells. In addition to being an improvement over existing technology with respect to containment of liquid and debris, the configuration of the openings also allows the soles of the feet and clothing to be kept above the contaminants.

In a particularly preferred embodiment, there are at least two troughs located along the common portion of the wall between two adjacent containment cells. The two troughs define a cleaning rib between them. The cleaning rib contacts the soles of the shoes resting on the mat and provides a cleaning action to remove dirt and other debris. The debris falls into the containment portions and is trapped. Finally, the best mode of the present invention is a configuration of containment portions where at least three areas of the wall of a single containment portion are common walls with other adjacent containment portions. Each common wall includes multiple ribs and troughs to maximize the cleaning of debris and optimize the flow of liquid from one cell to another. In addition to common walls, the containment portions may include other means to distribute debris and liquid to other containment portions. For example, a hub portion between the containment cells, the hub portion also containing openings or troughs, allows fluid communication between six or more containment portions, thus further increasing the ability of the containment portions to distribute and contain liquid and debris.

Other objects, advantages and capabilities of the present invention will become more apparent as the description proceeds, taken in conjunction with accompanying drawings, in which like parts have similar reference numerals.

### 4. BRIEF DESCRIPTION OF THE DRAWINGS

FIG. 1 is a top view of a floor mat incorporating features of the present invention;

FIG. 1a is a perspective view of the floor mat shown in FIG. 1;

FIG. 2 is a perspective view of adjacent cells of the present invention being presented in their most basic form for illustrative purposes;

FIG. 3 is a perspective view of adjacent cells of the present invention being presenting in their most basic form for illustrative purposes showing additional features of the present invention;

FIG. 4 is a perspective view of adjacent cells of the present invention being presenting in their most basic form for illustrative purposes showing additional features of the present invention;

FIG. 5 is a perspective view of adjacent cells of the present invention being presenting in their most basic form for illustrative purposes showing additional features of the present invention;

FIG. 6 is a perspective view of adjacent cells of the present invention being presenting in their most basic form for illustrative purposes showing additional features of the present invention;

FIG. 7 is a top view of a preferred embodiment of the present invention;

FIG. 8 is a sectional view taken along Section “A-A” of FIG. 7;

FIG. 9 is a top perspective view of the preferred embodiment shown in FIG. 7;

FIG. 10 is a bottom view of a preferred embodiment of the present invention;

FIG. 11 is a sectional view taken along Section “B-B” of FIG. 10; and

FIG. 12 is a bottom perspective view of the preferred embodiment shown in FIG. 10.

### 5. DETAILED DESCRIPTION

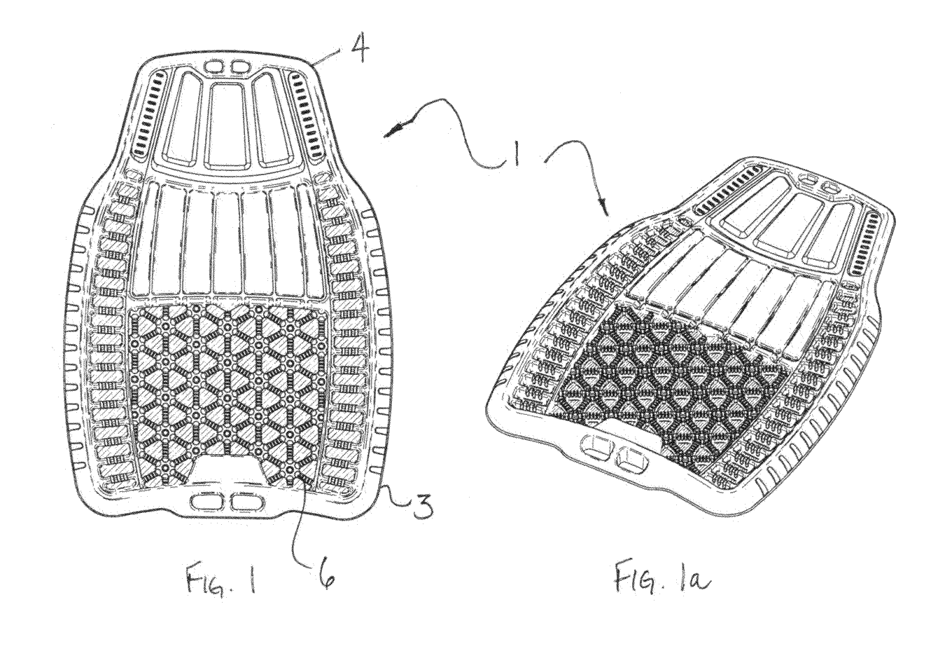

Referring to FIGS. 1 and 1a, the present invention 1 comprises an improved floor mat 3 designed to improve on the existing limitations of floor mats. The floor mat 1 includes a substrate 4 having a top portion 5 and a bottom portion 7 (see FIG. 8). The substrate 4 can be made of any material that is suitable for use as a floor covering such as rubber, PVC, either alone or in combination with carpeting. Preferably, the floor mat 3 of the present invention is made from rubber or other similar flexible, yet durable material that is easily cleaned and resists wear and tear. The top portion 5 of the mat includes a cellular topography 6. The topography 6 can be molded onto the mat 1 as a separate step or can be formed as a single injection molded part. The preferred method is an injection molded part where the bottom portion 7 works in parallel with the configuration of the top portion 5 as further explained below.

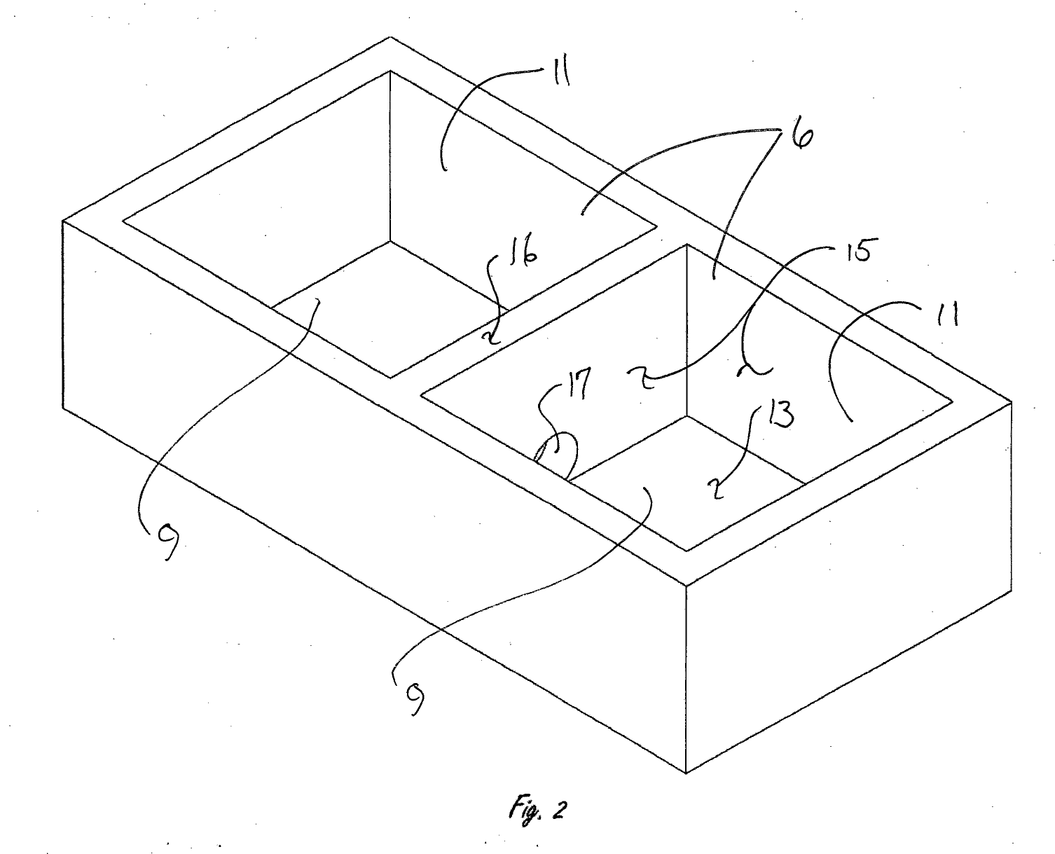

Referring to FIG. 2, the cellular topography 6 is shown in its most basic format for illustrative purposes. The cellular topography 6 comprises at least two cells 9. However, and preferably, substantially the entire surface of the mat 1 contains numerous cells 9. Each cell 9 has a containment portion 11 which is essentially an open compartment to catch, control and contain debris and liquid. Each containment portion 11 comprises a base 13 and a wall 15 extending upwardly from the base 13. Adjacent containment portions 11 share a common portion 16 of the wall 15 that extends upwardly from the base 13.

Each wall 15 preferably defines an opening 17 to allow fluid communication between the containment portions 11. The opening may be circular or can be any shape that can accommodate liquid transfer between cells. For configurations where numerous containment portions 11 are located on the top portion 5 of the mat 3, there may be several containment portions 11 adjacent to each other. Each containment portion 1 may share its wall 15 with several other adjacent containment portions 11. One or more of the common portions 16 of the wall may have an opening 17 to allow fluid communication between the containment portions 11. In this configuration the lowest portion of the opening 17 is located near the base 13.

Referring to FIG. 3, the opening 17 may also be located at an intermediate point along the wall 15 between the base and the top of the wall 15. FIG. 3 also illustrates that the bases 13 may be at differing elevations relative to the opening 17. The base 13 in cell 9A is at a different elevation than the base 13 in the adjacent cell 9B. In this configuration, the opening 17 is located near the base in cell 9A but is at an intermediate position along the wall in cell 9B.

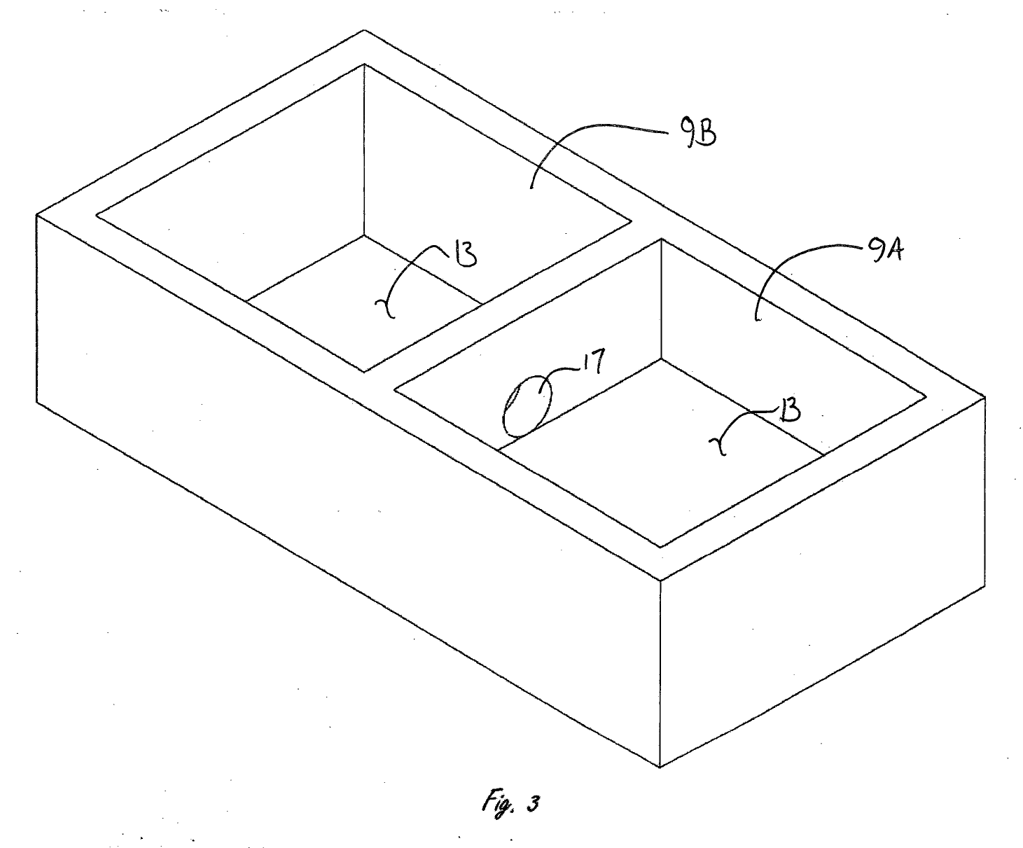

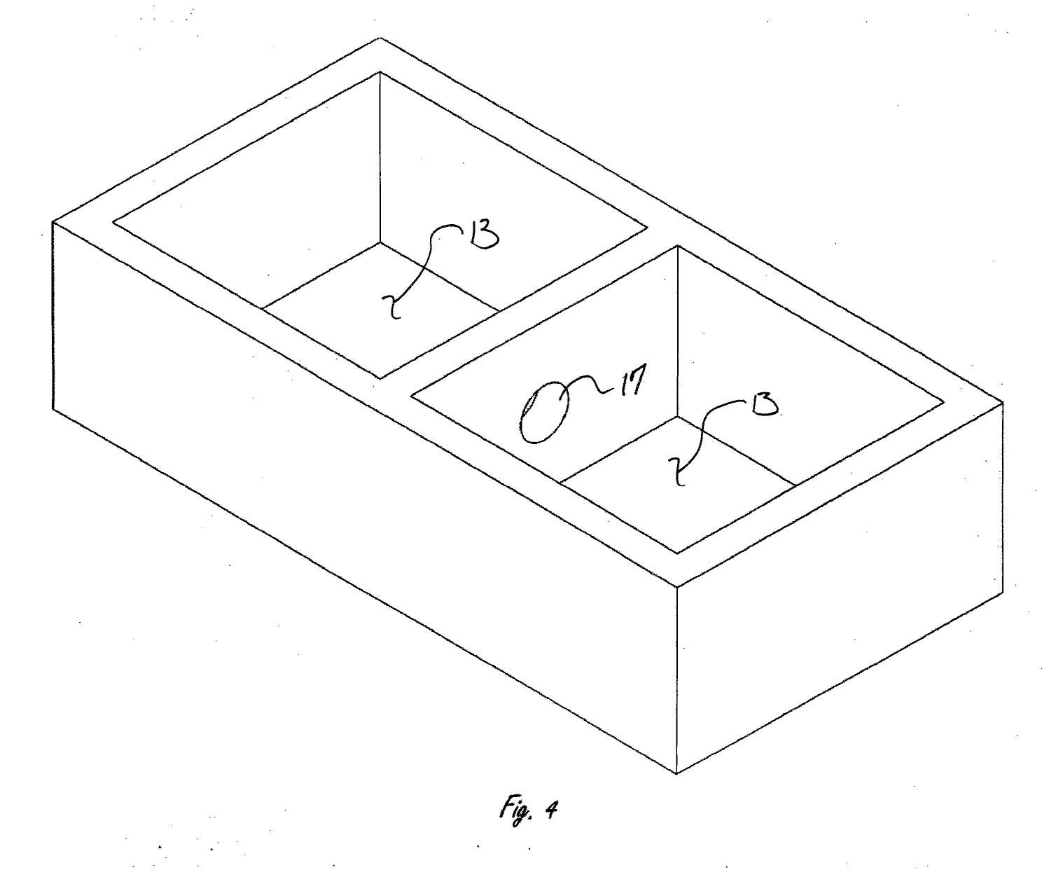

Referring to FIG. 4, the bases 13 are shown at the same elevation relative to the opening 17. As illustrated in FIG. 5, in a preferred embodiment, the opening 17 is a trough 19. The bottom of the trough 19 is at an elevation that is higher than the elevation of the base 13. Because of this configuration, each containment portion 11 can hold a certain amount of debris and liquid. However, if the volume of debris/liquid exceeds the capacity of the containment portion 11, the liquid will spill over into the adjacent cells 9 through the opening 17 or trough 19. Once the liquid is distributed to a sufficient number of containment portions 11, it ceases to spill over into other cells 9. In addition to being an improvement over existing technology with respect to containment of liquid and debris, the configuration of the openings 17 also allows the soles of the feet and clothing to be kept above the contaminants.

In a particularly preferred embodiment, as shown if FIG. 6, there are at least two troughs 19 located along the common portion 16 of the wall between two adjacent containment cells 9. The two troughs 19 define a cleaning rib 21 between them. The cleaning rib 21 contacts the soles of the shoes resting on the mat and provides a cleaning action to remove dirt and other debris. The debris falls into the containment portions 11 and is trapped. The cleaning ribs 21 may be staggered in height for added cleaning proficiency.

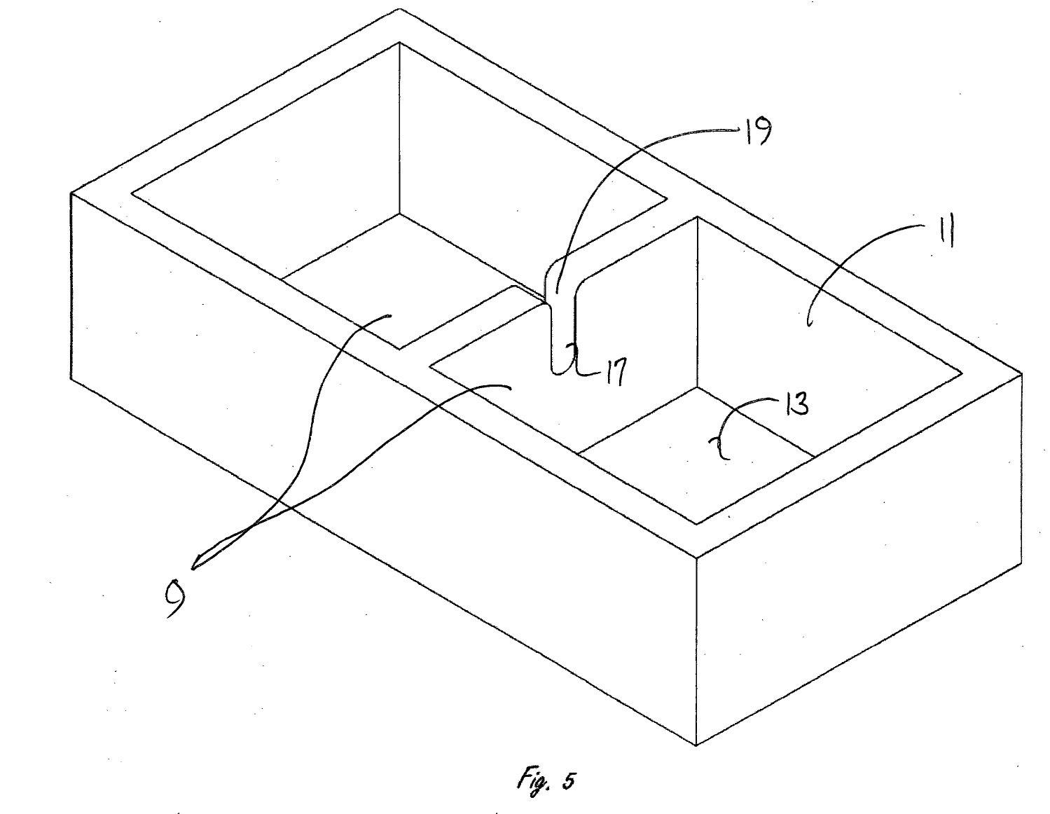

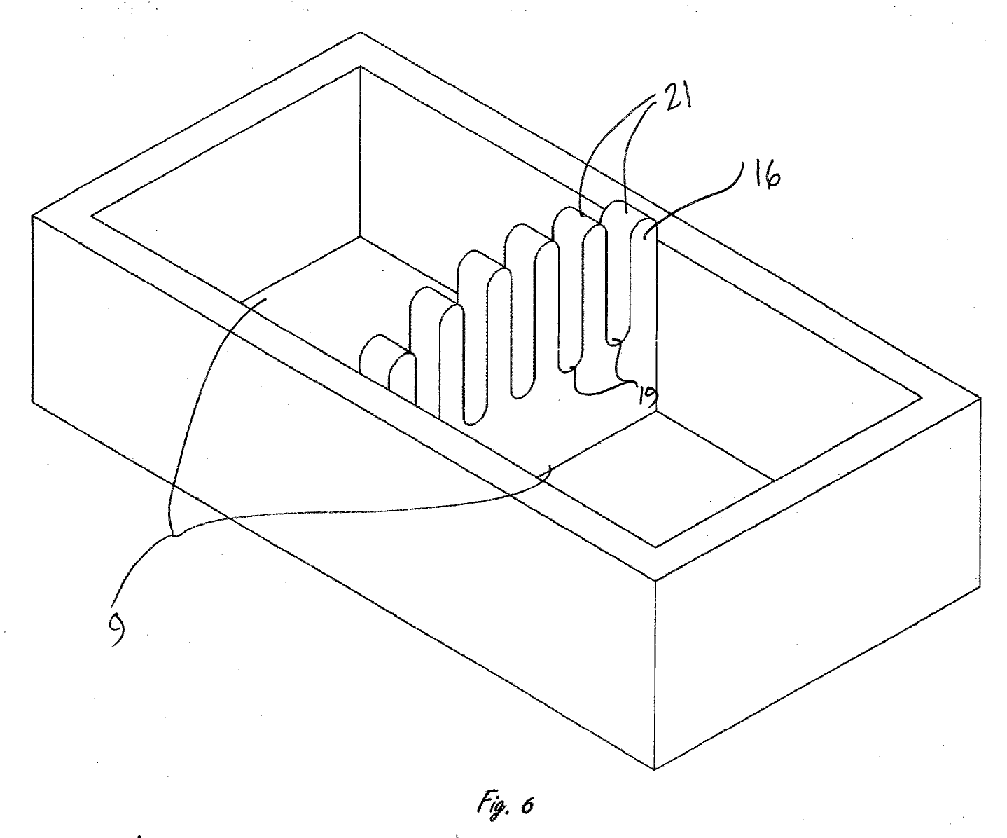

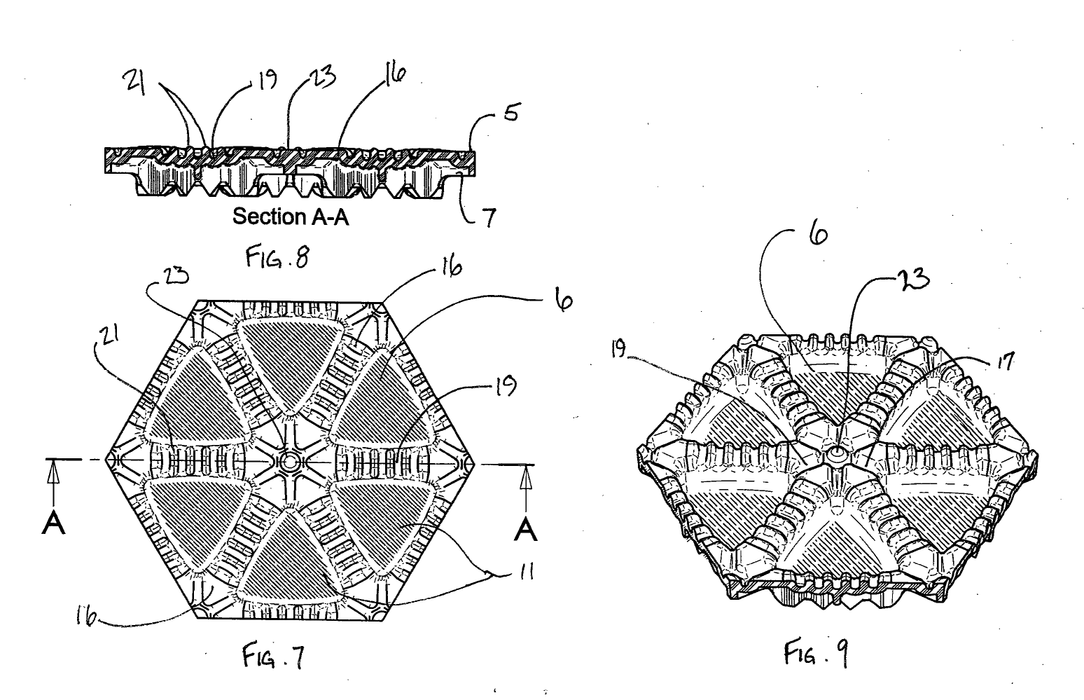

As illustrated in FIGS. 7-9, the best mode of the present invention is a configuration where the containment portions 11 are generally triangular in shape. The common walls 16 are located along each leg of the triangle. Each common wall 16 includes multiple ribs 21 and troughs 19 to maximize the cleaning of debris and optimize the flow of liquid from one cell 9 to another. In addition to common walls 16, the containment portions 11 may include other means to distribute debris and liquid to other containment portions 11. For example, a hub portion 23 between the containment cells 9, the hub portion 23 also containing openings 17 or troughs 19, allows fluid communication between six or more containment portions 11, thus further increasing the ability of the containment portions 11 to distribute and contain liquid and debris.

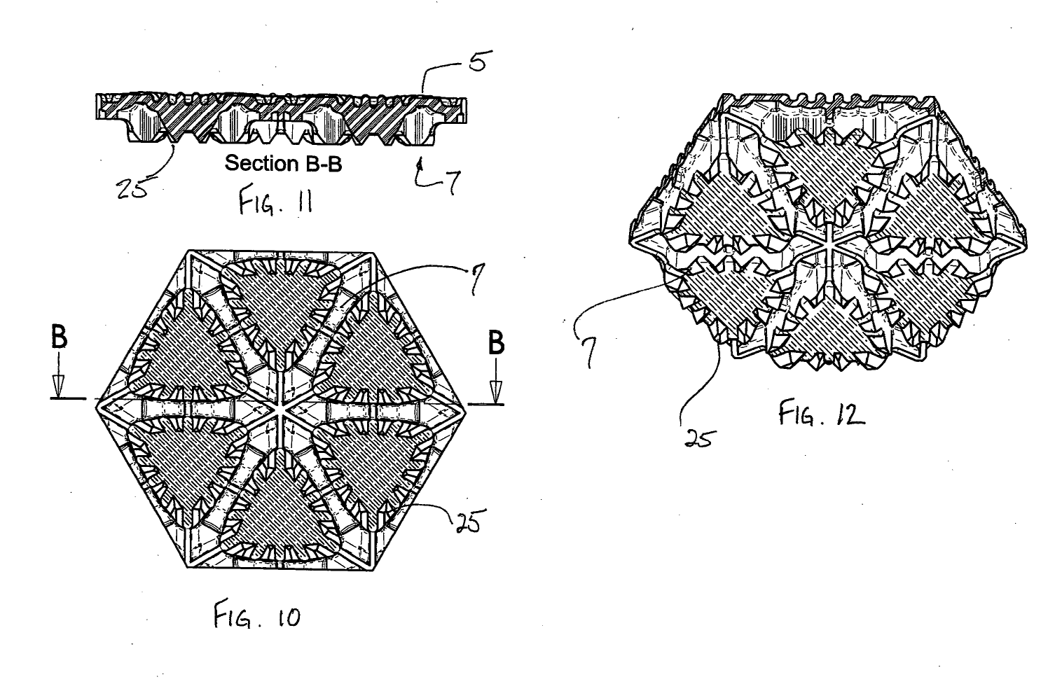

As shown in FIGS. 10-12, the bottom portion 7 includes cleats 25 formed into each cell 9 which provide superior slip control to prevent unwanted mat 3 movement. As discussed previously, the bottom portion 7 of the mat 3 is preferably formed in parallel with the top portion 5 of the mat 3 so that there is no impact on the aesthetic appearance of the mat 3 while still providing strength and support for the mat 3.

The description of the present invention contained herein is intended to be illustrative of the various embodiments but not limiting. The present invention is defined by the scope of the following claims.

1. An improved floor mat comprising:
a. A substrate having a top portion and a bottom portion;
b. At least two adjacent cells located on the top portion;
c. each cell having a containment portion comprising a base and a wall extending upward from said base;
d. the two cells sharing a common portion of the wall of each containment portion; and
e. said common portion of the wall defining an opening to allow fluid communication between the cells.

2. The floor mat of claim 1 wherein the opening is located near the base.

3. The floor mat of claim 1 wherein the opening is located at a position along the common wall above the base and below the top of the wall.

4. The floor mat of claim 1 wherein the base of one cell is located at a different elevation relative to the opening than the base of the adjacent cell.

5. The floor mat of claim 1 wherein said common wall comprises at least two troughs, the troughs being separated by a rib.

6. The floor mat of claim 5 wherein the bottoms of the troughs are higher in elevation than the base of the containment portions.

7. The floor mat of claim 5 wherein the common wall comprises at least three troughs, each trough being separated by a rib.

8. The floor mat of claim 5 wherein one rib protrudes higher than the other rib.

9. The floor mat of claim 3 wherein each cell is triangular in shape.
